(19) United States
(12) Patent Application Publication
(10) Pub. No.: US 2015/0336677 A1
(43) Pub. Date: Nov. 26, 2015

(54) IN-FLIGHT REFUELLING DEVICE FOR ELECTRIC STORAGE SYSTEM AND AIRCRAFT EQUIPPED WITH SUCH A DEVICE

(71) Applicant: EUROPEAN AERONAUTIC DEFENCE AND SPACE COMPANY EADS FRANCE, Paris (FR)

(72) Inventors: HICHEM SMAOUI, PARIS (FR); CHARLES NESPOULOUS, SAINT-CLOUD (FR); BRUNO RECHAIN, PARIS (FR); EMMANUEL JOUBERT, ISSY LES MOULINEAUX (FR); DIDIER ESTEYNE, SAUJON (FR)

(21) Appl. No.: 14/654,530

(22) PCT Filed: Dec. 19, 2013
(86) PCT No.: PCT/EP2013/077306

§ 371 Date: Jun. 20, 2015

(30) Foreign Application Priority Data
Dec. 21, 2012 (FR) 1262655

(51) Int. Cl. B64D 27/24; H02J 7/00; B64C 39/02; H01R 13/62

(52) U.S. Cl. CPC B64D 27/24; H01R 13/6205; H02J 7/0045; H02J 7/007; H02J 7/0026; H02J 7/0014; H02J 7/0021; B64C 39/02; B64C 2201/066

(57) ABSTRACT

A system for recharging the batteries carried on board an electrically powered aircraft. The system includes a charging aircraft, a device to temporarily and electrically connecting the charging aircraft to the electrically powered aircraft. The electrically powered aircraft includes a charge-regulating device.

### BACKGROUND OF THE INVENTION

1. Field of the Invention

The present invention relates to an in-flight refueling device of an electrically propelled aircraft which comprises an on-board electrical storage system, an aircraft equipped with such a device and a method for recharging batteries of an electrically propelled aircraft. The device provides for charging aircraft, aircraft likely to be recharged and appropriate connection means.

2. Technological Background

Since the launch of lithium-based batteries on the market, there has been an increasing emergence of airplane or helicopter demonstrators operating with electrical energy stored in electrochemical form in batteries.

It is clear that the power of the electric motors involved is very significant so there is therefore a need for a very significant input of on-board electrical energy.

The problem is that, in the short and even medium-term, the battery technologies do not allow the electric aircraft to achieve endurance levels similar to their counterparts that use gas or kerosene.

To increase the action radius of such aircraft, the American company Flight of the Century proposes producing an aircraft of mother vessel type with electric propulsion flying continually and capable of accommodating flying devices in the form of drones supporting batteries which complement the mother vessel and power it.

Once discharged, the drone is separated from the mother vessel and flies to a recharging station while another drone takes its place for the continuation of the flight.

Another solution envisaged by this company is to propose aircraft provided with battery packs in a plurality of parts that can be separated and jettisoned which increases the action radius of the supporting craft by progressively reducing its weight.

Other studies focus on laser or microwave-based remote energy transfer technologies.

In-flight refuelings are known in the field of aircraft with heat propulsion: an aircraft will serve as refueller and a second will come to be served. The refueller is generally an airplane with high capacities to have the maximum of fuel available for the airplanes which meet it. It drags behind it an in-flight refueling device which can take two different forms: either a rigid boom which will be controlled from the charging aircraft, or a basket at the end of a flexible pipe in which the airplane to be refueled will be refueled via a refueling boom. The latter is the system retained by the French airforce.

### BRIEF DESCRIPTION OF THE INVENTION

The present invention envisages, for a determined mission type, increasing the power reserve of an electrically propelled craft via an in-flight recharging process. This operation could be repeated, in the same flight, a number of times.

The present invention notably makes it possible to extend the mission times of the aircraft without increasing the weight of the on-board batteries and without producing a complex structure for jettisoning or mooring an additional vehicle.

For this, the present invention proposes a system for recharging on-board batteries in an electrically propelled aircraft, characterized in that it comprises a charging aircraft, means for temporarily electrically connecting the charging aircraft to the electrically propelled aircraft and a charge regulation device in the electrically propelled aircraft.

Advantageously, the charging aircraft and the temporary connection means are adapted to supply and transport a power supply current for the engine or engines of the electrically propelled aircraft in addition to the battery recharging current.

The on-board batteries preferably comprise fast-charge batteries that are the object of the recharging by the recharging system.

The temporary connection means are preferably designed to withstand the turbulences while being suitable for being disconnected safely in case of emergency and at the end of refueling.

The temporary connection means advantageously comprise two complementary plug-in connectors one borne by a flexible cable or a boom from the charging aircraft, the other borne by a junction device of the electrically propelled aircraft, and comprise an electromagnetic device for connecting the two complementary plug-in connectors.

The charge regulation device advantageously comprises a circuit for balancing the charges on packs and cells of the on-board batteries.

According to a first embodiment, the charging aircraft is equipped with an electrical energy production system suitable for recharging the propulsion batteries of the electrically propelled aircraft.

According to an advantageous embodiment, the charge regulation device is a device for controlling the batteries which monitors, during the charging, the current, the voltage and the temperatures of the battery cells, is adapted to decide to disconnect from the charger or alert the pilot to do so in the case of overvoltage, overcharging of the cells or excessively high temperature, and is adapted to communicate with the charger of the refueling airplane in order to itself control the battery charging current.

The electrical energy production system can comprise a heat engine coupled to a generator and/or a fuel cell.

According to an alternative or complementary embodiment, the electrical energy production system comprises batteries or a hybrid system with a plurality of sources.

According to a particular embodiment, the charging aircraft is a drone.

The electrically propelled aircraft can further comprise an on-board system for generating electrical energy from kerosene or hydrogen as backup system for example.

According to a particularly advantageous embodiment, the charging aircraft, the temporary electrical connection means for connecting the charging aircraft to the electrically propelled aircraft and the charge regulation device in the electrically propelled aircraft are adapted to recharge all the packs of the on-board batteries at one time.

According to an alternative or complementary embodiment, the charging aircraft is itself electrically propelled.

The invention also relates to a method for recharging batteries of an electrically propelled aircraft by means of a system as claimed in any one of the preceding claims, for which:
the electrically propelled aircraft or its pilot detects a low state of charge of its batteries and contacts the closest charging aircraft;
the electrically propelled aircraft or its pilot ensures a perfect knowledge of the diversion terrains in the refueling area and the calculation of the flight time to reach them, and also checks the power reserve remaining at the time of refueling;
the electrically propelled aircraft approaches the charging aircraft which releases an electric cable to it equipped with temporary electrical connection means compatible with means of the electrically propelled aircraft;
an electrical connection is established between the electrically propelled aircraft and the charging aircraft;
the electrically propelled aircraft activates the process of recharging its on-board batteries;
at the end of the recharging of the batteries, the electrically propelled aircraft orders the disconnection and the releasing of the electrical connection means.

### BRIEF DESCRIPTION OF THE DRAWINGS

Other features and advantages of the invention will become apparent on reading the following description of a nonlimiting exemplary embodiment of the invention with reference to the drawings which represent:

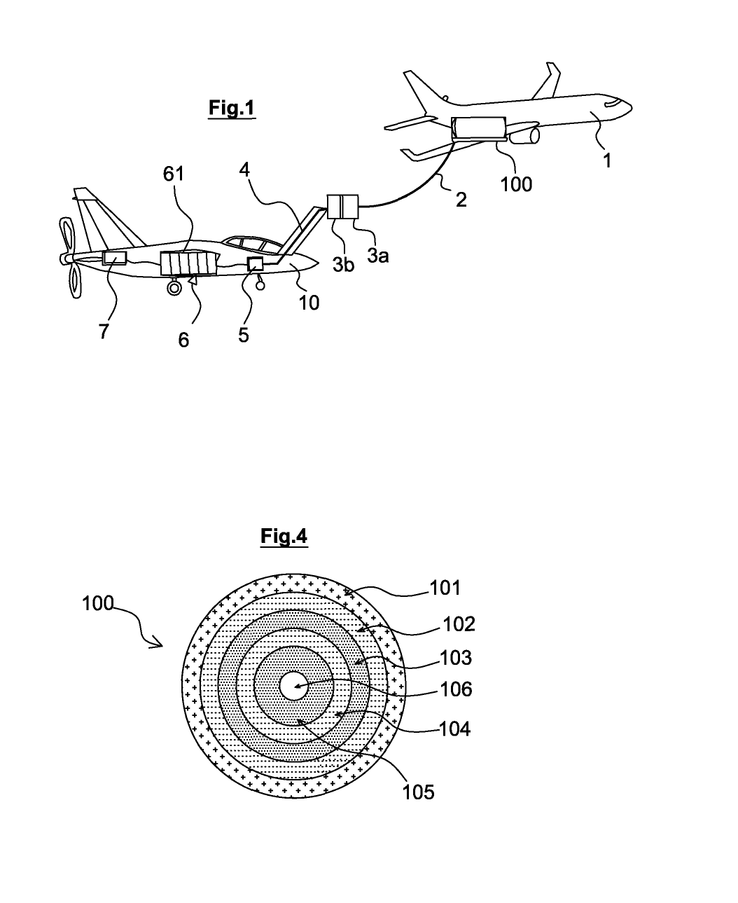

in FIG. 1: a schematic view of a step of recharging of batteries of an electrically propelled aircraft by a charging aircraft;

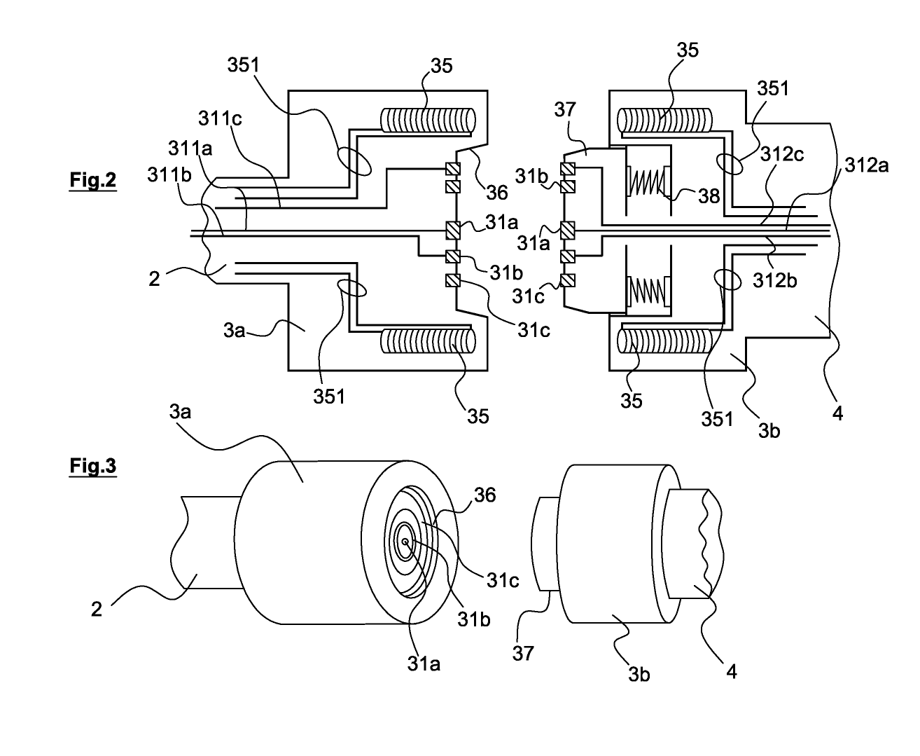

in FIG. 2: a cross-sectional view of a first exemplary embodiment of temporary connection means in the context of the invention;

in FIG. 3: a perspective view of the means of FIG. 2;

in FIG. 4: a front view of a second example of temporary connection means.

### DETAILED DESCRIPTION OF EMBODIMENTS OF THE INVENTION

The present invention proposes a system for recharging on-board batteries 6 in an electrically propelled aircraft 10 that can be recharged in flight.

The system schematically represented in FIG. 1 comprises a charging aircraft 1, means 2, 3a, 3b, 4 for temporarily electrically connecting the charging aircraft to the electrically propelled aircraft that can be recharged in flight and a charge regulation device 5 in the electrically propelled aircraft.

The temporary electrical connection means comprise, according to the example, a flexible electrical cable 2 dragged by the charging aircraft, here a reaction airplane, a first connector element 3a at the end of the cable, a second connector element 3b arranged at the end of a boom 4 from the aircraft 10 whose batteries are to be recharged.

The electric cable can be a flexible cable placed in the eye of the wind of the charging aircraft and can, as in the prior art of refueling with kerosene, comprise a basket to stabilize it and form a guiding cone for the second connector element 3b arranged at the end of the boom 4 from the electrically propelled aircraft 10 whose batteries are to be recharged.

The electrical cable can also be replaced by a boom controlled by an operator in the charging aircraft.

The temporary connection means comprise two complementary plug-in connectors 3a, 3b detailed more particularly in FIGS. 2 and 3.

As represented in FIG. 2, the temporary electrical connection means are designed to withstand the turbulences while being suitable for being disconnected safely in case of emergency and at the end of refueling.

For this, the complementary plug-in connectors 3a, 3b here comprise an electromagnetic device for coupling the two plug-in connectors comprising electromagnets 35 linked to a control device in the aircraft by wires 351.

According to the example, the complementary plug-in connectors comprise self-centering tapered coupling profiles 36, 37 and end-connecting coaxial annular contacts 31a, 31b, 31c.

On the charging aircraft side, the contacts are linked by electrical conductors 311a, 331b, 311c to the charging device.

On the side of the aircraft to be recharged, the contacts are linked by conductors 312a, 312b, 312c to the charge balancing device 5 and, possibly, to the power supply circuit of the engine or engines of the aircraft.

Here, the contacts 31a can be mass contacts jointly recharging the batteries and supplying power to the engine or engines, the contacts 31b being the battery charging contacts and the contacts 31c being the contacts supplying power to the electric engines of the aircraft during the charging.

It is also possible to consider four contacts, two for the recharging of the batteries and two for supplying power to the engines during the recharging.

The connection must be robust to turbulences, ensure safe locking and unlocking after refueling and allow for a rapid decoupling in case of emergency during the recharging. Here, this is made possible by the electromagnetic coupling means.

The mounting of one of the contact supports on a plate suspended by springs 38 here ensures that the contacts bear upon one another.

The electrical recharging plug-in connector 3b of the electrically propelled aircraft is here arranged on an arm 4, but could be arranged on the nose of the aircraft.

FIG. 3 represents the plug-in connectors, 3a the cable side and 3b the side of the electrically propelled aircraft with the tapered coupling parts 36, 37 facing one another.

To recharge all the on-board battery packs at one time, the circuit 5 for balancing the charge on the battery packs and the cells is an on-board circuit in the electrically propelled aircraft.

FIG. 4 proposes an alternative plug-in connector 100 suitable for refueling, this plug-in connector comprising, concentrically from the periphery to the center, a magnetic annular device 101, a positive annular contact 102 (a voltage of 250V can be envisaged), an annular insulating substrate 103, an annular ground track 104, an annular insulating substrate 105 and a central data transfer contact between the refueller and the battery charge management system.

The charging aircraft and the temporary connection means are adapted to supply and transport a power supply current for the engine or engines 7 of the electrically propelled aircraft in addition to the recharging current for the on-board batteries 6 of the electrically propelled aircraft. As seen above, this can be done with one or more additional contacts.

The charge regulation device 5 comprises a circuit for balancing the charges on the packs and the cells 61 of the on-board batteries. This makes it possible to simplify the wiring of the temporary links although this increases the on-board weight in the rechargeable electrically propelled aircraft.

The charge regulation device is for example of BMS (battery management system) type, which is a device for controlling the batteries which makes it possible to envisage more functionalities in the battery charge regulation device.

Typically, the BMS is a so-called smart device which monitors, during the charging, the current, the voltage and the temperatures of the battery cells.

The BMS can decide to disconnect from the charger or alert the pilot to do so in the case of overvoltage, overcharging of the cells or of excessively high temperature.

The BMS also makes it possible to communicate with the charger of the refueling airplane in order to itself control the battery charging current. This can be done by means of a computer bus (CAN bus for example) or by analogue control. It finally incorporates active or passive balancing means between the cells that make up the battery pack.

Ideally, the charging aircraft 1, the means 2, 3a, 3b, 4 for temporarily electrically connecting the charging aircraft to the electrically propelled aircraft and the charge regulation device 5 in the electrically propelled aircraft are adapted to recharge all the packs of the on-board batteries at one time.

To recharge the batteries of his or her craft, during the flight of the electrically propelled aircraft, the pilot decides to connect to a charging aircraft which makes it possible to recharge its batteries rapidly.

Based on the current batteries, an estimation for an aircraft having 2×10 kW engines, a recharging of the 2×30 kW batteries (250V×120 A) and a rate of charge of 3 C, the recharging time is estimated to be of the order of 15 minutes for an 80% recharge.

As seen above, the charging aircraft can also supply power to the engines of the electrically propelled aircraft during the recharging phase.

This supply of power can notably be provided through dedicated cables and contacts 31b in order to convey the necessary current and deliver the necessary voltage.

The charging aircraft can be an airplane equipped with an electrical energy production system 100 which can be a heat engine coupled to a generator, a fuel cell, batteries or a hybrid system with a plurality of sources.

It can also be a drone equipped with the same type of energy production system. The drone would make it possible to have more space and weight available for the production of electrical power.

The charging aircraft can itself be an electrically propelled aircraft.

As in the case of a conventional kerosene refueling, the refueling area must be determined and known in advance and, consequently, the safety in case of failure of the recharging for whatever reason, is taken into account by at least three factors:
the power reserve remaining at the time of the recharging;
the recharging altitude;
the perfect knowledge of the diversion terrains in the recharging area and the calculation of the flight time to reach them.

The system of the invention requires two pilots trained for this purpose or automatic piloting functions adapted to this task.

Moreover, the system of the invention is designed in the context of fast-recharge batteries which do, however, have a lower energy density than the slow-recharge batteries which means that the weight budget of the airplane can be affected thereby.

The fast-charge batteries can handle phases with high power demand such as taking off and climbing. Once recharged, these batteries make it possible to continue the flight after recharging.

It is, however, possible to combine batteries with high energy density, but in this case with slow recharging, for the take-off and flight start phases that are strong consumers, and fast-recharge batteries for the rest of the flight.

The recharging steps will then be conducted on the fast-recharge batteries which have to supply less energy than the batteries handling the take-off.

The invention makes it possible to optimize the choice of the batteries according to the missions to be carried out.

The implementation of the invention is broken down into a plurality of steps:
the airplane to be recharged 10 detects a low state of charge of its batteries and contacts the closest charging aircraft 1,
the airplane to be recharged 10 ensures a perfect knowledge of the diversion terrains in the refueling area and the calculation of the flight time to reach them. It also checks the power reserve remaining at the time of refueling,
the airplane to be recharged 10 approaches the charging aircraft 1 which releases an electric cable 2 to it that is equipped for and compatible with the electrical connection with electromagnetic locking 3b of the airplane to be recharged 10,
the airplane to be recharged 10 activates the process of recharging the on-board batteries 6,
at the end of the recharging of the batteries 6, the recharged airplane 10 slows down slightly. The resulting mechanical tension that is applied to the cable 2 then makes it possible to break the electrical connection 3a, 3b by developing a force greater than the attraction of the electromagnets between the plug-in connectors 3a and 3b.

The electrically propelled aircraft of the invention can further comprise an on-board system which makes it possible to generate electrical energy from kerosene, for example a turbogenerator or a small heat engine coupled to a generator which makes it possible to generate electrical energy from hydrogen, for example a fuel cell. This system makes it possible to improve the power reserve of the aircraft or provide backup in case of complete discharging of the batteries, but it adds to the on-board weight and adds complexity to the propulsion system.

Currently, the battery capacities are of the order of 200 Wh/kg with a recharging rate of 2 to 4 C, but it is possible to consider being able to design a regional airplane with 1000 Wh/kg batteries and a recharging rate of 10 C which would give, for an engine power of 2 MW and a battery capacity of 1.6 MWh, a flight time of one hour with a reserve of 10% and recharging times of 6 to 7 minutes.

It is also possible to envisage using cables and engines operating at superconductor temperature.

The invention is applicable to all types of electrically propelled aircraft, airplanes, helicopters, drones. This invention notably makes it possible to propose drones of reasonable dimensions, capable of handling medium distance missions, even long distance missions, but in this case managed by an on-board automatic system linked with a charging aircraft which could itself be automatic.

1-16. (canceled)

17. A system for recharging on-board batteries in an electrically propelled aircraft, comprising a charging aircraft and a temporary electrical connection device to electrically connect the charging aircraft to the electrically propelled aircraft temporarily, and a charge regulation device residing in the electrically propelled aircraft.

18. The system for recharging on-board batteries in an electrically propelled aircraft as claimed in claim 17, wherein the charging aircraft and the temporary electrical connection device are configured to supply and transport a power supply current to one or more engines of the electrically propelled aircraft in addition to a recharging current to the on-board batteries of the electrically propelled aircraft.

19. The system for recharging on-board batteries in an electrically propelled aircraft as claimed in claim 17, wherein the on-board batteries comprise fast-charge batteries.

20. The system for recharging on-board batteries in an electrically propelled aircraft as claimed in claim 17, wherein the temporary electrical connection device is configured to withstand turbulences and configured to be disconnect safely in case of emergency and at an end of refueling.

21. The system for recharging on-board batteries in an electrically propelled aircraft as claimed in claim 20, wherein the temporary electrical connection device comprises two complementary plug-in connectors, a first complementary plug-in connector borne by a flexible cable or a boom from the charging aircraft, a second complementary plug-in connector borne by a junction device of the electrically propelled aircraft, and an electromagnetic device to couple the two plug-in connectors.

22. The system for recharging on-board batteries in an electrically propelled aircraft as claimed in claim 17, wherein the charge regulation device comprises a circuit to balance charges on packs and cells of the on-board batteries.

23. The system for recharging on-board batteries in an electrically propelled aircraft as claimed in claim 17, wherein the charge regulation device controls the on-board batteries, and monitors, during recharging of the on-board batteries, a current, a voltage and temperatures of battery cells of the on-board batteries, the charge regulation device is configured to disconnect from a charger of the charging aircraft or to provide an alert to a pilot of the electrically propelled aircraft to disconnect from the charger in at least one of the following cases: overvoltage, overcharging of the battery cells or an excessively high temperature, and the charge regulation device is configured to communicate with the charger of the charging aircraft to control a battery charging current.

24. The system for recharging on-board batteries in an electrically propelled aircraft as claimed in claim 17, wherein the charging aircraft is equipped with an electrical energy production system configured to recharge the on-board batteries of the electrically propelled aircraft.

25. The system for recharging on-board batteries in an electrically propelled aircraft as claimed in claim 24, wherein the electrical energy production system comprises a heat engine coupled to a generator.

26. The system for recharging on-board batteries in an electrically propelled aircraft as claimed in claim 24, wherein the electrical energy production system comprises a fuel cell.

27. The system for recharging on-board batteries in an electrically propelled aircraft as claimed in claim 24, wherein the electrical energy production system comprises batteries or a hybrid system with a plurality of sources.

28. The system for recharging on-board batteries in an electrically propelled aircraft as claimed in claim 17, wherein the charging aircraft is a drone.

29. The system for recharging on-board batteries in an electrically propelled aircraft as claimed in claim 17, wherein the electrically propelled aircraft further comprises an on-board system to generate electrical energy from kerosene or hydrogen.

30. The system for recharging on-board batteries in an electrically propelled aircraft as claimed in claim 17, wherein the charging aircraft, the temporary electrical connection device and the charge regulation device in the electrically propelled aircraft are configured to recharge all packs of the on-board batteries at one time.

31. The system for recharging on-board batteries in an electrically propelled aircraft as claimed in claim 17, wherein the charging aircraft is an electrically propelled aircraft.

32. A method for recharging batteries of an electrically propelled aircraft, comprising the steps of:
detecting a low state of charge of the batteries of the electrically propelled aircraft;
contacting a closest charging aircraft of a recharging system to recharge the batteries of the electrically propelled aircraft, the recharging system comprises a temporary electrical connection device to electrically connect the charging aircraft to the electrically propelled aircraft temporarily;
calculating a flight time by the electrically propelled aircraft or its pilot to reach a refueling area in accordance with diversion terrains in the refueling area and a power reserve remaining at a time of refueling;
releasing an electric cable to the electrically propelled aircraft approaching the closest charging aircraft, the electrically propelled aircraft and the closest charging aircraft being equipped with compatible temporary electrical connection device;
establishing an electrical connection between the electrically propelled aircraft and the closest charging aircraft through the temporary electrical connection device;
activating a recharging process of recharging the batteries by a charge regulation device of the electrically propelled aircraft;
requesting a disconnection and release of the temporary electrical connection device by the electrically propelled aircraft at an end of the recharging process.
